(19) United States
(12) Patent Application Publication
(10) Pub. No.: US 2025/0156803 A1
(43) Pub. Date: May 15, 2025

(54) STOCK TAKING ASSISTANT METHOD AND SYSTEM

(71) Applicant: Captana GmbH, Ettenheim (DE)

(72) Inventors: Michael UNMÜSSIG, Ettenheim (DE); Thomas SCHWARZ, Hohberg (DE)

(73) Assignee: Captana GmbH, Ettenheim (DE)

(21) Appl. No.: 18/838,456

(22) PCT Filed: Feb. 22, 2022
(86) PCT No.: PCT/EP2022/054465

§ 371 Date: Aug. 14, 2024

(51) Int. Cl. G06Q 10/087; G06V 10/20; G06V 10/25

(52) U.S. Cl. CPC G06Q 10/087; G06V 10/25; G06V 10/255

(57) ABSTRACT

A method that comprises the process steps listed below, namely:
automatically capturing a product location with the help of a camera and generating a digital product location image of the product location with the help of the camera, wherein the product location is used for placing at least one product,
automatically recognizing that the product location is empty by computerized evaluation of the product location image,
digitally documenting the absence of the product at the product location.

### TECHNICAL FIELD

The invention relates to a method and a system for stock-taking support.

### BACKGROUND

The legally required annual stock-take in a shop typically requires each item in the shop to be counted and the number of each product determined to be recorded. However, this process is extremely laborious, particularly when it has to be carried out in shops that have several thousand items in their range.

Against this background, the object of the invention is to provide a method and a system by which a more efficient stock-taking process is facilitated.

### SUMMARY OF THE INVENTION

This object is achieved by a method according to claim 1. The subject matter of the invention is therefore a method comprising the process steps listed below, namely automatically capturing a product location with the help of a camera and generating a digital product location image of the product location with the help of the camera, wherein the product location is used for placing at least one product, automatically recognizing that the product location is empty by computerized evaluation of the product location image and digitally documenting the absence of the product at the product location.

This object is further achieved by a system according to claim 10. The subject matter of the invention is therefore a system, in particular an electronic product and/or price display system, comprising:

Cameras, wherein the cameras are provided for capturing product locations, wherein each product location is used for placing at least one product and wherein the cameras are provided for generating images of product locations for the captured product locations, wherein the system is designed by computerized evaluation of the product location image for automatic recognition that at least one of the product locations is empty, and wherein the system is designed for digitally documenting the absence of the product at the product location that has been identified as empty.

The method and the system therefore allow for automatic detection and documentation when a zero quantity is reached in stock levels of the product at the respective product location; in other words, automatic detection and documentation that the stock level of the product at the product location concerned is zero at a specific time. The product for which the zero quantity has been found during the year (i.e. at a time other than the time when the overall stock-take is conducted) need therefore—in those countries where the legal framework of stock-taking allows it—no longer be taken into account in the overall or main stock-taking. This is sometimes referred to in the jargon as zero-inventory checking. The technical measures of the method, as well as of the system, therefore additionally significantly facilitate the overall or main stock-taking, because this product, for which the attainment of a zero quantity has been detected, no longer needs to be manually recorded.

The advantage that the time required in order to carry out an overall or main stock-take can be drastically reduced, because product locations previously identified as empty are automatically identified and documented for the overall or main stock-take therefore goes hand-in-hand with the measures according to the invention. This also significantly increases the security of the stock-taking process, because an empty product location is automatically recognized and the corresponding information is automatically documented. Potential errors caused by humans are thereby completely eliminated and the necessary error-free documentation is guaranteed.

The method and also the system according to the invention can be implemented exceptionally well and, above all, with little additional effort in warehouses or shops, in order to make the stock-taking process run more efficiently there and therefore to simplify it.

Further particularly advantageous embodiments and developments of the invention are derived from the dependent claims and the following description.

Particularly in the case of a shop, but also in the case of a warehouse, display units are usually attached to the shelves, wherein the display units show product and/or price information. The display units can be conventional paper-based display units. Nowadays, however, electronic display units often referred to in the technical jargon using the term Electronic Shelf Labels or ESL for short, are frequently used. These are typically controlled by a server or a cloud-based software application with the help of a network of access points and are thereby provided with product and/or price information.

The camera used for automatic capture comprises a lens and an image sensor, wherein objects located within the field of view of the camera are projected or displayed onto the image sensor through the lens. Based on this projection, the image sensor generates a digital image of the object or the scene located within the field of view of the camera. This may be, for example, a shelf containing one or multiple product locations. The digital image then contains at least one digital product location image that represents the respective product location.

The camera can be configured to be freely movable. It may be a freely movable camera, used as a standalone unit or attached to or integrated into a camera-carrying device, for example glasses, a shopping trolley or a handheld device such as a mobile phone or tablet computer, and moved through the space in which a stock-take is to be carried out, such as the shop or warehouse, for example. A freely movable camera allows the capture of multiple product locations at different positions in the space in time-ordered fashion. This allows even large areas to be fully captured over time with as few cameras as possible, but not simultaneously.

Therefore, automatic capture with the help of a permanently installed camera with a field of view directed, in particularly permanently, at the one product location at least has proved particularly advantageous.

Depending on the local conditions, the lens used or also the zoom function of the camera, a scene with multiple product locations, or just a single product location, can therefore be located within the field of view of the camera. In addition, the camera can also be operated in such a manner that it successively focuses or zooms in on different areas of its maximum field of view, thereby providing details of its field of view for further image processing.

The permanently installed camera can be positioned, for example, on the ceiling of the room, on the shelf, in shelf dividers or in the electronic display unit, and from there automatically capture one or multiple product locations.

With a correspondingly large number of cameras, suitably positioning and alignment can ensure that all product locations in a warehouse or shop are automatically captured, in particular simultaneously. Changes in the product stock at a product location can easily be detected due to the permanently consistent orientation of the cameras, which means that the absence of a product at the respective product location can reliably be determined. Particularly advantageous is the aspect that the time at which the zero quantity occurs at the respective product location can be a substantially time-clearly determined, so that synchronized capture is ensured for all product locations.

It should be noted that a mixed configuration of permanently installed and movable cameras can also be used for automatic capture.

Furthermore, it has proved particularly advantageous that the automatic recognition that the product location is empty includes obtaining product information. Obtaining the product information makes it possible to determine which product is missing from the product location identified as empty, meaning which product should be present there.

The obtaining of the product information can take place directly on the server in this case. For this purpose, the camera is connected to the server via wireless or wired communication (with the help of a communication unit of the camera). The camera transmits the scene within its field of view, which may include one or more product locations, as the captured product location image to the server, where it is automatically determined, on the one hand, based on software, whether a product location is empty and it is also automatically determined, on the other hand, based on software, which product location it is. In this case, the latter can be achieved, for example, by image recognition, wherein adjacent product locations that are not recognized as empty, or also the relevant display unit(s), particularly those of the product location identified as empty, is/are taken into account, in order to identify the product belonging to the empty product location. For product identification, the image or the objects identified within it or digitally analyzable information content (the readable content of the display unit(s)) is analyzed by software.

However, it has proved particularly advantageous for the functionality of the server discussed in the previous paragraph to be provided directly by the camera or the computer within the camera. Consequently, the volume of data to be transmitted to the server can be substantially reduced, because image data does not need to be continuously transmitted to the server, and the computing power of the computer within the camera is fully utilized, enabling decentralized image processing to be used directly within the camera.

Therefore, it has proved particularly advantageous if obtaining the product information includes receiving product information data, particularly provided by a server, at the camera, wherein the previously mentioned communication unit of the camera is used, with the help of which product information data is transmitted from the server to the (respective) camera.

Obtaining the product information from the server allows fully automatic—decentralized—identification of the product provided at the product location identified as empty, because the product information indicates which product belongs to the empty product location concerned.

The respective field of view of the camera, so including the product locations contained therein, that has been determined and stored beforehand is known to the server, as is the shelf occupancy, i.e. the identity of the products at the planned product locations assigned to them, wherein this is laid down, in other words stored, in an occupancy data structure. For the product locations within the respective field of view of the camera, the server provides the relevant product information and, if applicable, also the expected arrangement of the products as previously stored.

An occupancy data structure of this kind can be realized, for example, as a three-dimensional (3D) floor plan. With the help of the 3D floor plan, for example, each product location can be represented or characterized by its three spatial coordinates (or by a coordinate range describing the respective product location) and a product identification number (e.g. a digital representation of an EAN code or the like) that identifies the product assigned to the product location.

By obtaining the product information at the camera, which is generally only necessary when the product configuration on the shelf changes, so typically only after longer operating periods, the camera (ultimately its computer) is therefore made aware of the identity of the product provided for the respective product location. As soon as the camera automatically recognizes an empty product location within its field of view, it can transmit this information along with the correct identification of the missing product to the server.

According to a further embodiment of the invention, the obtaining of the product information is carried out autonomously in the camera with the help of the camera's computer, in particular using computer vision.

In this embodiment, the camera is designed to autonomously recognize in automatic fashion whether a product location within its field of view is empty and also to autonomously determine which product is associated with this product location that has been identified as empty.

In the present case, computer vision should be understood to mean software that allows digital images to be analyzed, in order to extract information content from the real scene represented by the digital image. This is also in line with the scientific field also known as computer vision. This software can preferably also be self-learning in the sense of artificial intelligence. Other software and/or hardware-based solutions can of course also be used to realize the autonomous operation of the camera.

The camera software therefore makes it possible to determine initially, entirely on the camera side (in a decentralized manner), which product is located at the respective product location, in terms of obtaining the product information, and over time also to determine the absence of the product at the respective product location, in terms of the automatic recognition that the product location is empty.

For obtaining the product information, the software can, for example, be trained in advance with the appearance of the product or products that are typically found at the product location or within the captured product locations, using corresponding data sets.

An empty product location can, for example, be recognized on the one hand by detecting the full-area product location and, on the other hand, by noting the absence of the product that was at this product location during a capture of the product location at an earlier point in time.

A particularly reliable identification of the product location, in terms of the obtaining of the product information, is provided, for example, if at least one product or product location code (hereafter referred to simply as “code”) is located within the field of view of the camera, allowing an inference to be drawn about the product that should be at the product location and/or the product location itself. A code of this kind may be in the form of a barcode, a QR code, a symbol or a combination of symbols, text or a pattern, for example. This code can be found and interpreted, so particularly decoded, by the computer within the camera in the product location image.

The code can be applied to the base of the shelf, for example, so that it becomes detectable by the camera as soon as the shelf space is empty. computer therefore recognizes the code, checks whether there are actually no products remaining in the rest of the product location i.e. that the shelf space is empty and interprets the code to reference the corresponding product information, as this relationship might have been stored in a table available within the camera previously, for example.

The code can also be attached to the free end of the base of the shelf, for example, so on a display unit attached thereto (e.g. a shelf label), for example. This shelf label, located in the immediate vicinity of the product location, is captured by the camera and appears as part of the digital product location image. In this case, the camera computer checks the product location image for the code, on the one hand, in order to determine which product should be at the product location. On the other hand, the computer performs object recognition to check whether the corresponding product is at the product location or whether the product location is empty.

As discussed above, electronic display units are increasingly used today. The method can be used particularly advantageously in this case if electronic display units are used to display the code. The code can be represented in the form of text, in this case, for example as the product name, a barcode, or something similar. The code can correspond to the identification code of the electronic display unit or the logically linked product thereto in this case. Therefore, the code, i.e. the product information, can be easily displayed on a screen of the electronic display unit in this case. Typically, a code of this kind is transmitted to the display unit wirelessly or via wired communication after the electronic display unit is fastened to the shelf. In addition, plain text describing the product can simply be used as the code that is displayed.

In summary, therefore, the identity of the product associated with the product location, or the identity of the product location itself, can be determined with the help of the camera computer by automatically evaluating product information positioned corresponding to the product location.

If it is determined that the product location is empty, this is documented digitally. For this purpose, the product location image is preferably stored as an image file or video file, in particular. Furthermore, in a documentation data structure such as this, in which the product location image is documented, the time, date and/or location of the capture and/or a camera ID, as well as the product identity, etc., can be stored, in order to guarantee clear documentation and traceability.

In general, it is advantageous for the digital documentation to comprise immutable storage.

This allows for (legally) secure proof that the zero quantity has been reached. Digital documentation therefore provides a reliable basis for stock-taking, including the zero quantity at a specific product location, where products for which the absence of the product at the product location has already been digitally documented in the past can be confidently ignored.

It has proved particularly advantageous in this case that the digital documentation comprises immutable storage for a predefined period. In this case, the digital documentation is preferably stored or preserved at least for a period of time until actual the stock-taking is conducted. Particularly preferably, the predefined period extends beyond that, however. The predefined period can be determined by the prevailing regulations and laws of a country, ensuring that the zero quantity is stored or digitally documented in a traceable form for as long as required for proper legally compliant stock-taking documentation.

Therefore, when a zero quantity is reached at a product location, this is automatically detected and documented, so that products that have reached a zero quantity no longer need to be taken into account in further stock-taking processes. For conducting the actual stock-taking, it has proved particularly advantageous to visualize a status display with the help of at least one electronic display unit, in particular with the help of all electronic display units, making it possible to identify the product location that was recognized as empty in the past. In order to realize this process feature, the system includes electronic display units, each of these display units being provided to display product and/or price information for a product and being positioned corresponding to a product location, wherein the system, particularly the electronic display units, is designed so that with the help of at least one electronic display unit, in particular with the help of all electronic display units, the status display can be visualized, making it possible to identify the product location recognized as empty in the past.

Therefore, for an employee performing the stock-take, it is immediately apparent which products have already reached a zero quantity in the past and have therefore already been automatically digitally documented, allowing the employee to ignore these products, thereby speeding up the stock-taking process substantially.

The status display in this case can be visualized by text, a pattern or a colour on the screen of the electronic display unit, for example, or by the illumination or flashing of an LED on the electronic display unit.

In this case, those electronic display units can visualize a status display for which a zero quantity has been determined at the associated product location, meaning those electronic display units whose associated products are no longer to be taken into account for stock-taking. Complementarily, however, those electronic display units can also visualize a status display for which no zero quantity has been determined at the associated product location, meaning those electronic display units whose associated products are still to be taken into account for the stock-take. Additionally, those electronic display units whose associated products are no longer to be taken into account for the stock-take can visualize a status display, such as a text “OK” on the screen, while those electronic display units whose associated products are still to be taken into account for the stock-take can visualize a different status display, such as a text “TO-DO” on the screen and/or a flashing LED, or just no special status display, but simply the typical product information. The server therefore decides which electronic display units should show a status display or should not show a status display.

So that the electronic display unit can visualize the status display, the information that the zero quantity has been detected, i.e. that the product location is empty, is transmitted from the camera to the electronic display unit. This transmission can be done wirelessly straight from the camera to the electronic display device. However, it has proved particularly advantageous for the information to be transmitted via the server to the electronic display unit, because the entire stock-taking process is managed via the server.

Control information is therefore transmitted to the electronic display unit, so that the electronic display unit visualizes the status display, making it clear to an employee involved in the stock-taking whether a product location or a product needs to be taken into account for the stock-take or not.

The employee need therefore only include a portion of the product locations in the stock-take. It has proved advantageous in this case for a stock-taking status for a specific product location to be supplied by an electronic display unit or a portable user device.

The portable user device may be a device that allows the employee conducting the stock-take to document the stock-take or the stock-taking progress. Therefore, the portable user device can be, for example, a tablet computer or a mobile phone with corresponding software or an application.

The stock-taking status in this case describes the number of products at the product location or the counted products (quantity). The stock-taking status can include additional information in this case, such as the time and place of the stock-taking status creation. The employee can therefore enter the counted (or otherwise determined, for example, weighed) quantity (or other corresponding size) of the respective product into the portable user device.

This measure allows for automatic confirmation of the stock-taking capture of the product. For this purpose, a link between the portable user device and the electronic display unit can be established as a result of NFC communication, for example, so that the entered variable (quantity) can be immediately assigned to the electronic display unit. However, the link can also be established by the portable user device capturing an optical code, for example a barcode or QR code of the electronic display unit. This optical code can also be the status display, which informs the employee that the product belonging to this electronic display unit still needs to be included in the stock-take. A manual selection of the appropriate product or product location can also be made.

The stock-taking status can therefore be provided by the portable user device and/or by the electronic display unit, in other words transmitted and received by the server, and processed. The server preferably stores the stock-taking status of the individual products digitally in a stock-taking status data structure. Therefore, once the stock-taking has been completed, the stock-taking status data structure with its individual entries, for example, represents the quantity or weight of the individual products.

According to another aspect, it has proved advantageous that when the associated product location has been recognized as empty in the past, the electronic display unit either refuses communication with the portable user device or transmits a hint data set to it. The hint data set prompts the portable user device to display information informing the employee that a zero quantity has already been automatically detected for the associated product in the past. The electronic display unit itself can also display this hint itself.

In this context, different permissions can also be provided for the employee. It can be provided, for example, that for employees without special permission, manual entry for this product, for which a zero quantity has already been detected in the past, is prevented. Confirmation from the employee can also be required if they want to edit or add to an already recorded data set. Higher permission may be required for this. It should be noted that even with editing or additions of this kind, editing or deletion of the digital product image itself created in relation to the zero quantity detected is preferably excluded.

According to one aspect of the invention, for a product that has been automatically recognized as having an empty product location, the digitally documented absence of the product at the product location is stored as the stock-taking status for the respective product.

The documentation data structure, which includes the product location image and product identity and possibly additional information such as time and place, is stored as the stock-taking status for the product concerned in the stock-taking data structure.

Consequently, the stock-taking status data structure is configured in such a manner that for those products for which a zero quantity was recorded in the past, the digital product location image (either as such or via a link) is saved, showing and thereby proving that the zero quantity has actually been attained. For the remaining products, on the other hand, the product status, in other words the quantity, weight, etc., determined during the manual stock-take, is stored.

Finally, it should also be mentioned in general terms that the electronic devices and equipment discussed naturally include electronics. The electronics can be discrete or integrated, or a combination of the two. Microcomputers, microcontrollers, Application Specific Integrated Circuits (ASICs), possibly in combination with analog or digital electronic peripheral components, may also be used. Many of the functionalities of the devices mentioned are realized with the help of software executed on a processor of the electronics, possibly in conjunction with hardware components. Devices designed for radio communication typically comprise an antenna configuration as part of a transceiver module for sending and receiving radio signals, as well as a modulator and/or a demodulator. The electronic devices may also comprise an internal electrical power supply, which can be realized using a replaceable or rechargeable battery, for example. The devices may also be wired, powered either by an external power supply or also by means of power over LAN. Likewise, a radio-based power supply can be provided by means of power over Wifi. Battery-operated electronic display units are preferably equipped with energy-saving electrophoretic screens.

These and other aspects of the invention are derived from the figures discussed below.

### BRIEF DESCRIPTION OF THE FIGURES

The invention is further explained below with reference to the attached figure using exemplary embodiments, to which the invention is not however limited. The figure schematically shows:

FIG. 1: a camera capturing a shelf for stock-taking support.

### DESCRIPTION OF THE EXEMPLARY EMBODIMENTS

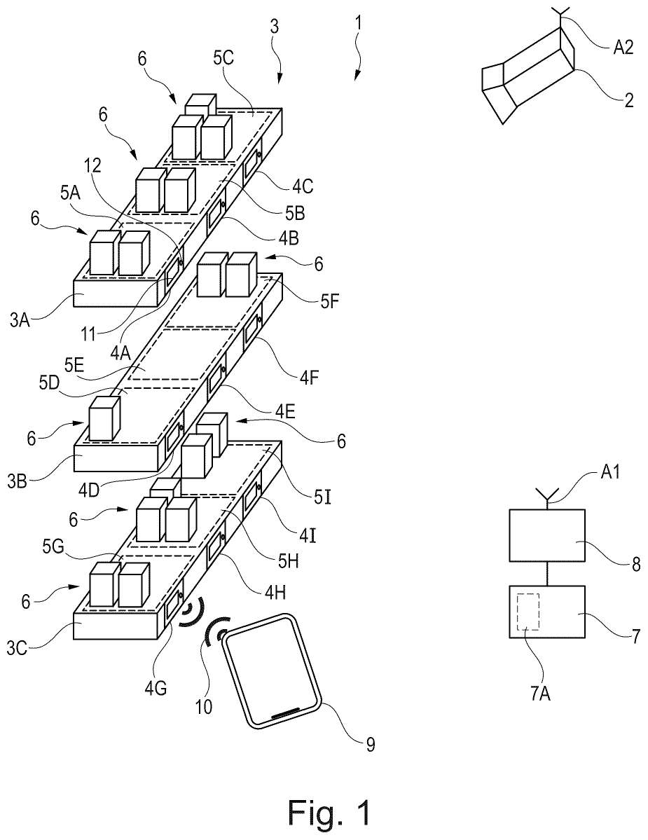

FIG. 1 shows a detail of a retail shop with a single shelf 3 that comprises three shelf levels 3A, 3B and 3C. In the retail shop, a system 1 for performing a stock-taking support process is also installed. The system 1 includes a camera 2 with an integrated computer that captures the shelf 3 within its field of view. Each shelf level 3A, 3B and 3C comprises three electronic display units, referred to as ESLs 4A to 4I, on its front side, in other words its side facing the camera. Each ESL 4A to 4I comprises a screen for 11 for displaying information (such as product and/or price information) and an LED 12 (only shown on a single ESL 4A to represent all ESLs 4A-4I) for signalling. Each ESL 4A to 4I is positioned corresponding to a product location 5A to 5I on the respective shelf level 3A-3C. Except for the middle product location 5E of the middle shelf level 3B, the position of each product location 5A to 5I holds at least one product 6 assigned to the respective ESL 4A-4I, in other words the product location 5A to 5I. The product 6 assigned to the middle product location 4E is therefore missing, meaning that the product location 4E is unoccupied, i.e. empty.

The system 1 also includes a server 7 that is coupled with an access point 8, through which the server 7 is wirelessly connected to the camera 2 and the ESLs 4A to 4I, which is structurally indicated by two antenna configurations AI and A2.

In addition, the system 1 includes a portable user device, designed as a tablet computer 9, operable by an employee who is not shown. The tablet 9 is also wirelessly connected to the server 7 via the access point 8.

In the present case, it is assumed that the tablet 9 has already been used to establish a logical link between the ESLs 4A to 4I and the products 5 positioned correspondingly to them. At the time of the creation of the logical link, all product locations 5A-5I were naturally occupied by products 6, as, for example, after the initial placement of the products. For creating the logical link, a barcode of the respective product 6 and a barcode displayed on the screen 11 of the corresponding ESL 4A to 4I were scanned with a camera of the tablet 9, and both barcodes were transmitted to the server 7, where the logical link was generated and stored. The barcode of the product 6 contains the product identity or product information identifying the product. As an alternative to scanning the barcode from the screen 11 of the ESL 4A to 4I, the respective ESL 4A to 4I can also be identified by means of near field communication (NFC) 10. The server 7 creates a linkage data structure from these associated information pairs (on the one hand, information concerning the identity of the respective ESL and, on the other hand, information concerning the identity of the respective product), representing which ESL 4A to 4I is linked to which product 6, i.e. the logical connection.

Furthermore, let us assume that with the help of the camera 2 and image analysis of the digitally captured scene, the product locations 5A to 5I of the products 6 were determined. The image analysis in this case can occur directly in the camera 2 or the raw data generated (substantially) by the camera can be transmitted to the server 7, where the image analysis then takes place. However, the determination of the product locations 5A-5I can also be done manually, for example with the help of the tablet 9. Using the localization of the products 6 determined in this manner at their respective product locations, an occupancy data structure is generated, enriching the linkage data structure with location information that specifies where the respective product locations 5A-5I for the products 6 are located, and consequently also the location of the respective ESLs 4A-4I.

To support the stock-taking, camera 2 now captures the shelf 3 and the product locations 5A to 5I located therein (e.g. in a substantially continuous manner, in order to be able to detect changes in the occupancy of the respective product location) and generates product location images. By means of computer vision, the product location images are analyzed by the computer of camera 2.

Now, let us assume that over time all products have been removed from product location 5E. Once this situation occurs, the computer of camera 2 detects during the analysis of the product location images that the middle product location 5E of the middle shelf level 3B is empty. This is then documented by storing in an immutable manner the respective product location image, or a sequence of relevant product location images, showing the empty state. For this purpose, the product location images are transmitted to the server 7 and stored there in an immutable memory 7A together with the product identification also (possibly the ESL identification), the time and date of the generation of the product location images, and a camera ID that uniquely identifies the camera 2 generating the product location image in a documentation data structure.

If a stock-take is now conducted, as commonly takes place in retail at a given point in time each year, the employee starts a corresponding program on their tablet 9, whereupon the tablet 9 informs the server 7 of the start of the stock-taking process, and whereupon the server 7 puts the ESLs 4A to 4I into stock-taking mode. In this stock-taking mode, ESLs 4A-4I visualize their status, which was previously transmitted to them by the server 7, in a status display with the help of their screens 11.

For those product locations 5A-5I for which an entry already exists in the documentation data structure, the server causes the screen of the corresponding ESL 4A-4I to display a large “X” as the status display. This applies in the present case to ESL 4E, whose corresponding product location 5E was already identified as empty in the past.

For those product locations 5A-5I for which no entry exists in the documentation data structure, the server 7 causes them to display the relevant product information on their screens 11 and to have their LED 12 flash. This applies in the present case to ESL 4A to 4D and 4F to 4I, for which no empty product locations 5A-5D and 5F-5I were identified in the past.

Simultaneously with the start of the stock-taking mode, the information represented by the documentation data structure is transferred by the server 7 into a stock-taking status data structure. In this stock-taking data structure, the quantities of the respective products 6 manually recorded by employees and the identification of the products 6 are generally documented and therefore stored. However, when transferring the information represented by the documentation data structure into the stock-taking status data structure, a link to the immutable product location images is stored for those products 6 for which an entry already exists in the documentation data structure. Therefore, an entry is automatically generated in the stock-taking data structure for those products 6 for which an entry already exists in the documentation data structure, making a manual recording of the relevant quantities of these products 6 obsolete. The stock-taking data structure thereby generated contains, after the stock-taking has been completed, not only the stock-taking statuses of the manually recorded products 6, but also the automatically created stock-taking statuses for those products 6 for which at least once in the past an empty product location was identified and documented with the corresponding product location image, which is now referenced from the stock-taking data structure by the aforementioned link.

During the stock-taking activities, the staff can immediately recognize which product locations are already saved in the stock-taking status data structure with the help of the status display visualized by the ESLs 4A to 5I, because a large “X” is displayed on the screen of the corresponding ESLs (in this case, ESL 4E). The employee does not conduct a manual stock-take for this product location 5E. However, a manual stock-take is conducted for all other product locations.

As illustrated in FIG. 1 at the bottom left for product location 5G, for example, the employee holds the tablet 9 up to ESL 4G for manual stock-taking of the products 6 located there. ESL 4G and the tablet 9 initiate a near-field communication NFC 10 in this case, during which the identity of the ESL 4G is transmitted to the tablet 9. The employee then enters the number of products located at each product location 5G associated with the ESL 4G onto the tablet 9. In this case, there are two products 6 at this product location 5G. After confirming the input, the tablet 9 transmits the data to the server 7, where it is integrated into the stock-taking status data structure. The server 7 then instructs the ESL 4G to display an updated status, causing the LED 12 the ESL 4G to light up continuously, so the employee knows that this ESL 4G, and the associated product location 5G, has already been included in the stock-take. The relevant ESL 4G is also deactivated to prevent a further, potentially erroneous, double stock-taking of the product 6 assigned to it.

Once the stock-taking is complete, all LEDs 12 of the ESLs 4A to 4D and 4E to 4I, for which a stock-taking status has been recorded, therefore light up continuously. Alternatively, in order to save energy, the LEDs can of course also be successively deactivated after the respective products 6 have been included in the stock-take. Once all product locations 5A to 5D and 5F to 5I to be recorded manually have been recorded, the tablet 9 receives notification from the server 7 that the stock-take is complete. The employee can confirm this on the tablet 9, thereby completing the stock-take. All ESLs 4A-4I are then returned to their normal operating mode by the server 7 and display the respective product and/or price information once again.

According to another embodiment, the automatically generated documentation data structure can also be supplemented with the results of the manual stock-take, thereby creating the stock-taking status data structure, particularly also at the same time in the immutable memory.

According to another embodiment, the LED 12 can also be used to visualize the status of the products already automatically recorded in the documentation data structure using the corresponding ESLs 4A-4I, whereas the LEDs 12 for those products that still need to be taken into account during the manual stock-take are turned off.

According to another embodiment, the use of LEDs 12 can be omitted and the entire status display can be handled using the screens. Therefore, ESLs 4A-4I without LEDs 12 can also be used.

Finally, it should be noted that any number of product locations and cameras can be used in shops or warehouses to implement the according method to the invention. Particularly in large shops with several thousands, often tens of thousands, of different products, the method presented here speeds up the stock-taking process substantially, as only a fraction of the product locations has to be manually recorded.

Finally, it should also be noted that the figure described in detail above is merely an exemplary embodiment that can be modified in various ways by a person skilled in the art without departing from the scope of the invention. For the sake of completeness, it should also be noted that the use of the indefinite articles “a” or “an” does not preclude the possibility that the relevant features may also be present multiple times.

1. A method that comprises the process steps listed below, namely:
automatically capturing a product location (5A-5I) with the help of a camera (2) and generating a digital product location image of the product location (5A-5I) with the help of the camera (2), wherein the product location (5A-5I) is used for placing at least one product (6),
automatically recognizing that the product location (5A-5I) is empty by computerized evaluation of the product location image,
digitally documenting the absence of the product (6) at the product location (5A-5I).

2. The method according to claim 1, wherein the automatic capture takes place with the help of a permanently installed camera (2) with a field of view directed, in particularly permanently, at the one product location at least (5A-5I).

3. The method according to claim 1, wherein the automatic recognition that the product location (5A-5I) is empty includes obtaining product information.

4. The method according to claim 3, wherein obtaining the product information includes receiving product information data, particularly provided by a server (7).

5. The method according to claim 3, wherein the obtaining of the product information is carried out autonomously in the camera (2) with the help of a computer of the camera (2), in particular using computer vision.

6. The method according to claim 1, wherein the digital documentation comprises immutable storage, in particular for a predefined period of time.

7. The method according to claim 1, wherein with the help of at least one electronic display unit (4A-4I), in particular with the help of all electronic display units (4A-4I), a status display is visualized, making it possible to identify the product location (5A-5I) recognized as empty in the past.

8. The method according to claim 1, wherein a stock-taking status for a specific product location (5A-5I) is supplied by an electronic display unit (4A-4I) or a portable user device (9).

9. The method according to claim 7, wherein for a product (6) that has been automatically recognized as having an empty product location (5A-5I), the digitally documented absence of the product (6) at the product location (5A-5I) is stored as the stock-taking status.

10. A system (1), in particular an electronic product and/or price display system (1), comprising:
cameras (2), wherein the cameras (2) are provided for capturing product locations (5A-5I), wherein each product location (5A-5I) is used for placing at least one product (6) and wherein the cameras (2) are provided for generating images of product locations for the captured product locations (5A-5I),
wherein the system (1) is designed by computerized evaluation of the product location image for automatic recognition that at least one of the product locations (5A-5I) is empty, and
wherein the system (1) is designed for digitally documenting the absence of the product (6) at the product location (5A-5I) that has been identified as empty.

11. The system (1) according to claim 10, wherein the system (1) comprises electronic display units (4A-4I), wherein each of these display units (4A-4I) is provided to display product and/or price information for a product (6) and is positioned corresponding to a product location (5A to 5I), wherein
the system (1), in particular the electronic display units (4A-4I) are designed in such a manner that with the help of at least one electronic display unit (4A-4I), in particular with the help of all electronic display units (4A-4I), a status display can be visualized making it possible to identify the product location (5A-5I) that was recognized as empty in the past.
